(19) United States
(12) Patent Application Publication
(10) Pub. No.: US 2017/0122096 A1
(43) Pub. Date: May 4, 2017

(54) CEMENT PLUG DETECTION SYSTEM AND METHOD

(71) Applicant: Tesco Corporation, Houston, TX (US)

(72) Inventors: Willem George Durtler, Calgary (CA); Robert Strother-Stewart, Calgary (CA); Dimitar Dimitrov, Calgary (CA); Hendrik Leroux, Calgary (CA); Brian Dewald, Calgary (CA)

(21) Appl. No.: 15/341,701

(22) Filed: Nov. 2, 2016

Related U.S. Application Data
(60) Provisional application No. 62/250,768, filed on Nov. 4, 2015.

(51) Int. Cl. E21B 47/09; G01V 3/26; E21B 33/12

(52) U.S. Cl. CPC E21B 47/0905; E21B 33/1208; G01V 3/26; E21B 33/14

(57) ABSTRACT

In accordance with one aspect of the disclosure a method includes positioning a cement plug in a casing string, completing a casing cementing process, launching the cement plug down the casing string, and detecting a magnetic field of an electro-magnetic transmitter coupled to the cement plug or a magnet disposed on an outer surface of the casing string with a magnetic sensor disposed on the outer surface of the casing string.

### CROSS-REFERENCE TO RELATED APPLICATION

This application claims priority to and benefit of U.S. Provisional Patent Application No. 62/250,768, entitled “CEMENT PLUG DETECTION SYSTEM AND METHOD,” filed Nov. 4, 2015, which is herein incorporated by reference in its entirety.

### BACKGROUND

Embodiments of the present disclosure relate generally to the field of drilling and processing of wells. More particularly, present embodiments relate to a system and method for detecting and/or tracking a cement plug during casing operations.

Cement plugs are typically utilized during casing operations to substantially remove cement from an interior surface of wellbore tubulars. In conventional oil and gas operations, an annulus is formed around the wellbore tubulars within a formation. During completion operations, casing (e.g., wellbore tubulars) may be secured to the formation via cementing. The cement is pumped through the casing to fill the annulus and secure the casing to the formation. After cement pumping is complete, the cement plug is introduced into the casing to clear the cement from the interior surface of the casing. As a result, cementing operations may continue with little to no mixing of cement with the drilling/displacement fluids pumped through the casing.

### BRIEF DESCRIPTION

In accordance with one aspect of the disclosure a cement plug detection system includes a cement plug comprising a ferrous element and a sensor system. The sensor system includes a belt configured to be disposed about a casing string, a plurality of magnet sensors coupled to the belt, a plurality of magnets coupled to the belt, wherein the plurality of magnets is configured to output a magnetic field, and a master controller configured to provide an indication that at least one of a plurality of magnet sensors has detected a change in the magnetic field of the plurality of magnetics caused by the ferrous element.

In accordance with another aspect of the disclosure, a system includes a cement plug comprising an electro-magnetic pulse generator configured to output an electro-magnetic field and a sensor system. The sensor system includes a belt configured to be disposed about a casing string and a plurality of sensor boards coupled to the belt, wherein each sensor board of the plurality of sensor boards comprises a first sensor and a second sensor, wherein the first sensors of the plurality of sensor boards are arranged in a first sensor array, and the second sensors of the plurality of sensor boards are arranged in a second sensor array.

In accordance with another aspect of the disclosure, a method includes positioning a cement plug in a casing string, completing a casing cementing process, launching the cement plug down the casing string, and detecting a magnetic field of an electro-magnetic transmitter coupled to the cement plug or a magnet disposed on an outer surface of the casing string with a magnetic sensor disposed on the outer surface of the casing string.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of a well being drilled with a plug tracking system, in accordance with present techniques;

FIG. 2 is a partially exploded perspective view of an embodiment of a cement plug having magnets of a plug detection system, in accordance with present techniques;

FIG. 3 is a partial cut-away perspective view of an embodiment of a plug detection system, illustrating a cement plug inserted into a casing string and a plug detection belt, in accordance with present techniques;

FIG. 4 is an exploded perspective view of an embodiment of a sensor system, in accordance with present techniques; and

FIG. 5 is a perspective view of an embodiment of a sensor system, in accordance with present techniques;

FIG. 6 is a schematic of an embodiment of a master controller of a plug detection system, in accordance with present techniques;

FIG. 7 is a schematic top view of an embodiment of a plug detection system, illustrating a configuration of magnets and sensors, in accordance with present techniques;

FIG. 8 is a schematic top view of an embodiment of a plug detection system, illustrating a configuration of magnets and sensors, in accordance with present techniques;

FIG. 9 is a schematic top view of an embodiment of a plug detection system, illustrating a configuration of magnets and sensors, in accordance with present techniques;

FIG. 10 is a schematic cross-sectional side view of an embedment of a plug detection system, illustrating a cement plug inserted into a casing string, in accordance with present techniques;

FIG. 11 is a schematic cross-sectional side view of an embedment of a plug detection system, illustrating a cement plug inserted into a casing string, in accordance with present techniques; and

FIG. 12 is a schematic cross-sectional side view of an embedment of a plug detection system, illustrating a cement plug inserted into a casing string, in accordance with present techniques.

### DETAILED DESCRIPTION

Present embodiments provide a system and method for detecting a position of a cement plug within a casing or other tubular. For example, during casing cementing operations, a plug (e.g., rubber plug) is used to separate cement from displacement fluid as the plug is launched to substantially remove cement from an interior surface of wellbore tubulars (e.g., casing). In certain embodiments, the plug includes a port to allow cement to pass through the plug and into the casing or tubular. After a desired amount of cement is pumped into the casing or tubular, a solid ball is launched to occlude the port of the plug. Thereafter, displacement fluid (e.g., water or a water mixture) is pumped behind the ball and plug, thereby creating pressure and causing the plug to be launched down the casing or tubular. Unfortunately, the plug is not visible within the casing or tubular, thereby creating difficulty in ascertaining whether the plug is properly positioned within the tubular or casing and/or whether the plug has properly been launched down the casing. Thus, present embodiments are directed to a system and method for detecting a position of the plug within the casing or tubular.

As discussed in detail below, a plug detection system includes at least one magnet, ferrous material, electro-magnetic pulse generator coupled to the plug for generating a static or alternating magnetic field inside the casing or tubular when the plug is positioned within the casing or tubular. Additionally, the plug detection system includes one or more sensors (e.g., magnetic sensors) and/or magnets positioned on an exterior side of the casing or tubular to detect the magnetic field of the magnet coupled to the plug. For example, the plug detection system may include a belt, strap, clamp, or other band to secure the one or more sensors and/or magnets to the exterior side of the casing. Before the cementing process is completed, the plug (e.g., annular plug) with the magnet(s), ferrous material, or pulse generator is positioned or “stabbed” into the casing or tubular. Thereafter, the band (e.g., belt, strap, clamp, etc.) having the one or more sensors and/or magnets is wrapped about the casing or tubular and moved up and down the casing until the sensors indicate detection of the plug (e.g., the magnet, ferrous material, and/or electro-magnetic pulse generator coupled to the plug). However, in other embodiments, the band having the one more magnets and/or sensors may be placed sufficiently below the presumed location of the plug, such that an operator is confident that the plug will necessarily travel past the belt once it is launched. Once the approximate location of the plug is detected, the band is secured to the casing beneath the plug. The ball to block the port of the plug is launched to block the port of the plug, and displacement fluid is then pumped into the casing above the plug. Once the plug is launched down the casing by the displacement fluid, the sensors of the band will detect the identifying signal of the plug as the plug travels down the casing past the sensors and provide an indication to a user or operator, thereby confirming a positive launch of the plug. As discussed in detail below, the plug detection system may have a variety of detection identifiers and/or sensor configurations, as well as other components to provide feedback to an operator or user regarding launching of the cement plug.

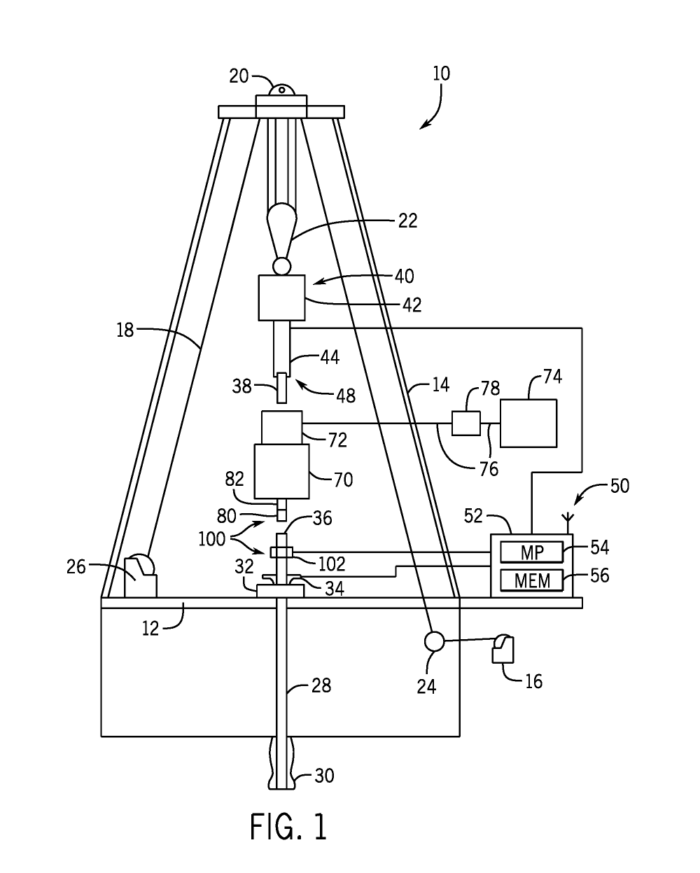

Turning now to the drawings, FIG. 1 is a schematic view of a drilling rig 10 in the process of drilling a well in accordance with present techniques. The drilling rig 10 features an elevated rig floor 12 and a derrick 14 extending above the rig floor 12. A supply reel 16 supplies drilling line 18 to a crown block 20 and traveling block 22 configured to hoist various types of drilling equipment above the rig floor 12. The drilling line 18 is secured to a deadline tiedown anchor 24, and a drawworks 26 regulates the amount of drilling line 18 in use and, consequently, the height of the traveling block 22 at a given moment. Below the rig floor 12, a casing string 28 extends downward into a wellbore 30 and is held stationary with respect to the rig floor 12 by a rotary table 32 and slips 34 (e.g., power slips). A portion of the casing string 28 extends above the rig floor 12, forming a stump 36 to which another length of tubular 38 (e.g., a section of casing) may be added.

A tubular drive system 40, hoisted by the traveling block 22, positions the tubular 38 above the wellbore 30. In the illustrated embodiment, the tubular drive system 40 includes a top drive 42 and a gripping device 44. The gripping device 44 of the tubular drive system 40 is engaged with a distal end 48 (e.g., box end) of the tubular 38. The tubular drive system 40, once coupled with the tubular 38, may then lower the coupled tubular 38 toward the stump 36 and rotate the tubular 38 such that it connects with the stump 36 and becomes part of the casing string 28. The casing string 28 (and the tubular 38 now coupled to the casing string 28) may then be lowered (and rotated) further into the wellbore 30.

The drilling rig 10 further includes a control system 50, which is configured to control the various systems and components of the drilling rig 10 that grip, lift, release, and support the tubular 38 and the casing string 28 during a casing running or tripping operation. For example, the control system 50 may control operation of the gripping device 44 and the power slips 34 based on measured feedback to ensure that the tubular 38 and the casing string 28 are adequately gripped and supported by the gripping device 44 and/or the power slips 34 during a casing running operation. In this manner, the control system 50 may reduce and/or eliminate incidents where lengths of tubular 38 and/or the casing string 28 are unsupported. Moreover, the control system 50 may control auxiliary equipment such as mud pumps, robotic pipe handlers, and the like.

In the illustrated embodiment, the control system 50 includes a controller 52 having one or more microprocessors 54 and a memory 56. For example, the controller 52 may be an automation controller, which may include a programmable logic controller (PLC). The memory 56 is a non-transitory (not merely a signal), tangible, computer-readable media, which may include executable instructions that may be executed by the microprocessor 54. The controller 52 receives feedback from other components and/or sensors that detect measured feedback associated with operation of the drilling rig 10. For example, the controller 52 may receive feedback from the plug detection system described below and/or other sensors via wired or wireless transmission. Based on the measured feedback, the controller 52 may regulate operation of the tubular drive system 40 (e.g., increasing rotation speed).

In the illustrated embodiment, the drilling rig 10 also includes a casing drive system 70. The casing drive system 70 is configured to reciprocate and/or rotate the tubular 38 (e.g., casing) during casing and/or cementing operations. In the illustrated embodiment, the casing drive system 70 is placed above the rig floor 12. However, in other embodiments the casing drive system 70 may be placed beneath the rig floor 12, at the rig floor 12, within the wellbore 30, or any other suitable location on the drilling rig 10 to enable rotation of the tubular 38 during casing and/or cementing operations. As mentioned above, in certain embodiments, the control system 50 may control the operation of the casing drive system 70. For example, the control system 50 may increase or decrease the speed of rotation of the tubulars 38 based on wellbore conditions.

The casing drive system 70 may be used during cementing operations to direct cement into the casing string 28. In the illustrated embodiment, the casing drive system 70 is coupled to a cement swivel 72 configured to supply cement for cementing operations. For example, the cement swivel 72 may receive cement from a pumping unit 74 via a supply line 76. Additionally, the casing drive system 70 may include an inner bore configured to direct the cement through the casing drive system 70 and into the casing string 28.

Furthermore, a plug 80 coupled to a casing drive system adapter 82 may be positioned within (e.g., “stabbed” into) the casing string 28. As mentioned above, the plug 80 may include a port or central passage that enables cement to flow from the casing drive system 70, through the plug 80, and into the casing 28. After the casing cementing process is completed, the plug 80 is used to substantially remove cement from an interior surface of the casing string 28. To this end, a ball launcher 78 positioned in the supply line 76 between the cement swivel 72 and the pumping unit 74 is configured to launch a ball through the casing drive system 70 to the plug 80. The ball occludes the port or central passage of the plug 80 to block fluid from passing across the plug 80. Once the ball is launched from the ball launcher 78 to block the port of the plug 80, a displacement fluid (e.g., water or water mixture) is pumped behind the ball and plug 80, which causes the plug 80 to be launched down the casing string 28. As the plug 80 travels down the casing string 28, the plug 80 cleans and/or removes cement from the inner surface of the casing string 28.

As mentioned above, present embodiments include a plug detection system 100 configured to detect a position and/or movement of the plug 80. The plug detection system 100 includes at least one magnet (e.g., rare earth magnet), ferrous material (e.g., ferrite element), or electro-magnetic pulse generator coupled to the plug 80. The plug detection system also includes a sensor system 102 disposed about the casing string 28 at the rig floor 12. The sensor system 102 includes at least one sensor (e.g., magnetic sensor) and/or at least one magnet supported by a belt, band, or other strap that secures the at least one sensor and/or at least one magnet to the exterior surface of the casing string 28 beneath the plug 80. For example, the at least one sensor of the sensor system 102 may be configured to detect the presence of a magnet (e.g., a magnetic field emitted by the magnet) coupled to the plug 80. In such an embodiment, when the plug 80 and the sensor system 102 are at a common axial location along the casing string 28, the sensor system 102 will provide an indication that the at least one sensor has detected the magnet coupled to the plug 80. Thus, when the plug 80 is launched down the casing string 28, the plug 80 will pass the sensor system 102, and the sensor system 102 will provide an indication that the plug 80 has passed the sensor system 102 (i.e., the plug 80 has launched). To provide this indication and other feedback, the sensor system 102 includes additional components that will be described in further detail below.

In another embodiment, the plug detection system 100 may include a ferrous material coupled to the plug 80. In such an embodiment, the sensor system 102 may include magnets and sensors (e.g., supported by a belt, band, or other strap wrapped about the casing string 28). When the plug 80 is launched down the casing string 28, the ferrous material attached or built into the plug 80 will extend and/or interrupt a magnetic field generated by the magnet(s) of the sensor system 102. The magnetic field extension or interruption may then be detected by the sensor(s) of the sensor system 102 when the plug 80 having the ferrous material passes the sensor system 102 during launching of the plug 80.

In another embodiment, the plug 80 may include an electro-magnetic pulse generator and/or transmitter. For example, the electro-magnetic generator and/or transmitter may include a battery and a coil that produces an electro-magnetic field. In such an embodiment, the sensor system 102 includes sensors (e.g., supported by a belt, band, or other strap wrapped about the casing string 28). When the plug 80 is launched down the casing string 28, sensors of the sensor system 102 will detect the electro-magnetic field generated by the electro-magnetic generator and/or transmitter attached or built into the plug 80 as the plug 80 passes the sensor system 102 during launching of the plug 80. In this manner, launching of the plug 80 down the casing string 28 may be verified.

It should be noted that the illustration of FIG. 1 is intentionally simplified to focus on the plug detection system 100 of the drilling rig 10, which is described in greater detail below. Many other components and tools may be employed during the various periods of formation and preparation of the well. Similarly, as will be appreciated by those skilled in the art, the orientation and environment of the well may vary widely depending upon the location and situation of the formations of interest. For example, rather than a generally vertical bore, the well, in practice, may include one or more deviations, including angled and horizontal runs. Similarly, while shown as a surface (land-based) operation, the well may be formed in water of various depths, in which case the topside equipment may include an anchored or floating platform. Furthermore, it will be appreciated that the disclosed detection system may have other applications where detecting movement of components within enclosed vessels or containers may be useful. For example, the presently disclosed embodiments may be useful for detecting the passage of a pipeline inspection gauge traveling inside an enclosed pipe. While only certain features of the disclosure have been illustrated and described herein, many modifications and changes will occur to those skilled in the art. It is, therefore, to be understood that the appended claims are intended to cover all such modifications and changes as fall within the true spirit of the disclosure.

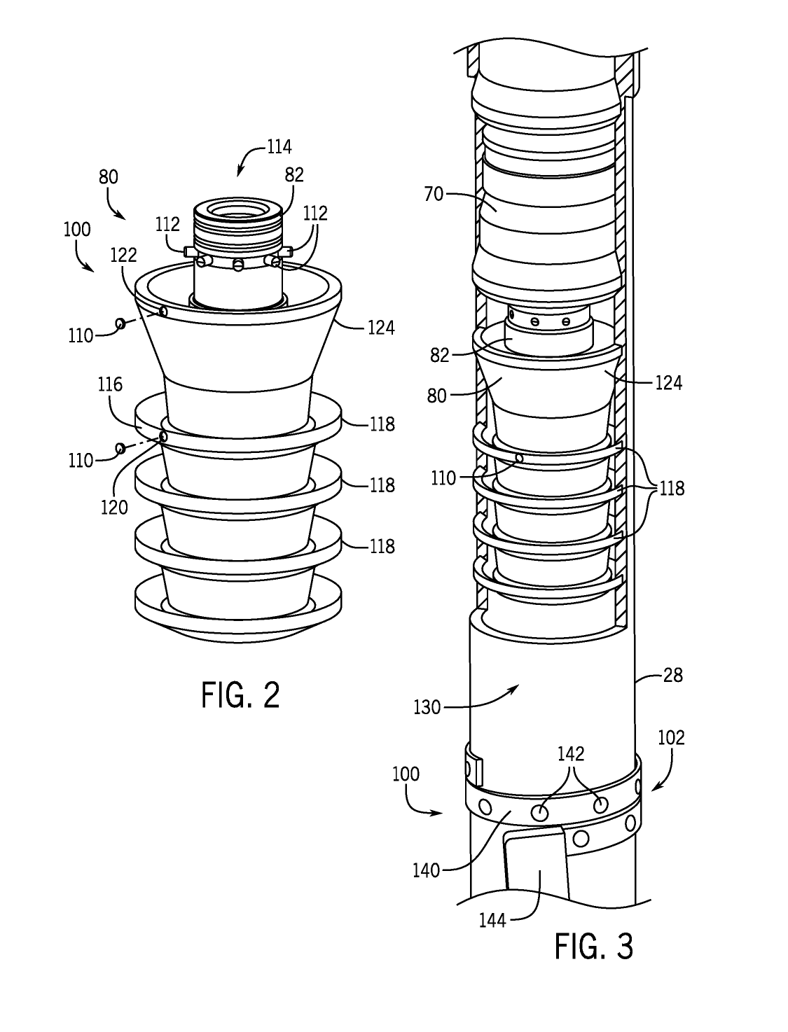

FIG. 2 is a partially exploded perspective view of an embodiment of the plug 80 having magnets 110 (e.g., rare earth magnets) of the plug detection system 100. However, as discussed below, other embodiments of the plug 80 may include other non-magnetic components of the plug detection system 100, such as ferrite elements and/or an electro-magnetic pulse generator or transmitter. The plug 80 may be formed from a flexible, yet resilient material, such as rubber, plastic, neoprene, or other elastomer. The illustrated embodiment also includes the casing drive system adapter 82, which couples the plug 80 to the casing drive system 70 as the plug 80 is inserted or “stabbed” into the casing string 28. The casing drive system adapter 82 may be coupled to the casing drive system 70 via shear pins 112. Once the ball is launched from the ball launcher 78, the ball may block a port 114 of the casing drive system adapter 82, which fluidly couples an internal passage of the casing drive system 70 with an internal passage (e.g., port) of the plug 80. With the ball blocking the port 114, displacement fluid may be pumped behind the plug 80 and the casing drive system adapter 82. As pressure from the displacement fluid builds behind the plug 80, the shear pins 112 may shear, thereby releasing the casing drive system adapter 82 and plug 80 from the casing drive system 70 and launching the plug 80 down the casing string 28.

As mentioned above, the plug detection system 100 shown in FIG. 2 includes magnets 110 that are coupled to the plug 80. The magnets 110 may be any suitable size. The size of the magnets 110 may depend on the location of the plug 80 where the magnets 110 are positioned or attached. The size of the magnets 110 may also depend on the strength of the sensors of the sensor system 102 that detect the magnets 110, a size or thickness of the casing string 28, or other parameters. In one embodiment, the magnets 110 may be approximately 0.25″ in diameter and 0.0625″ thick. In certain embodiments, the size of the magnets 110 may be minimized to reduce costs, complexity, performance complications, and so forth.

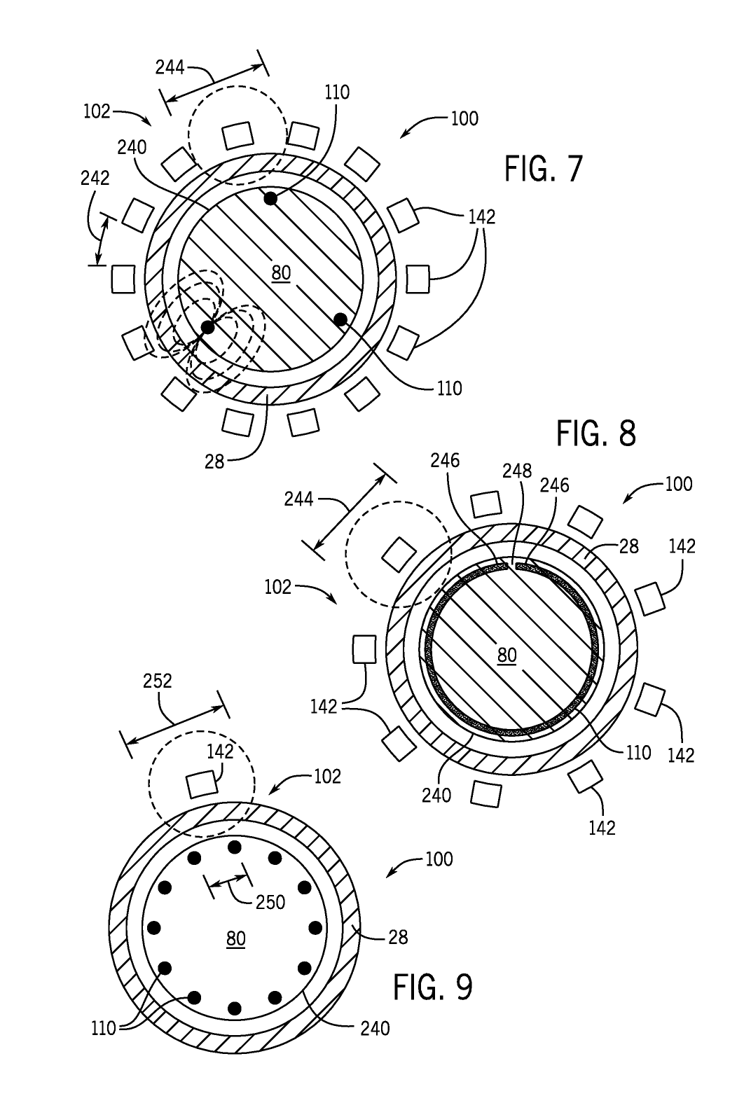

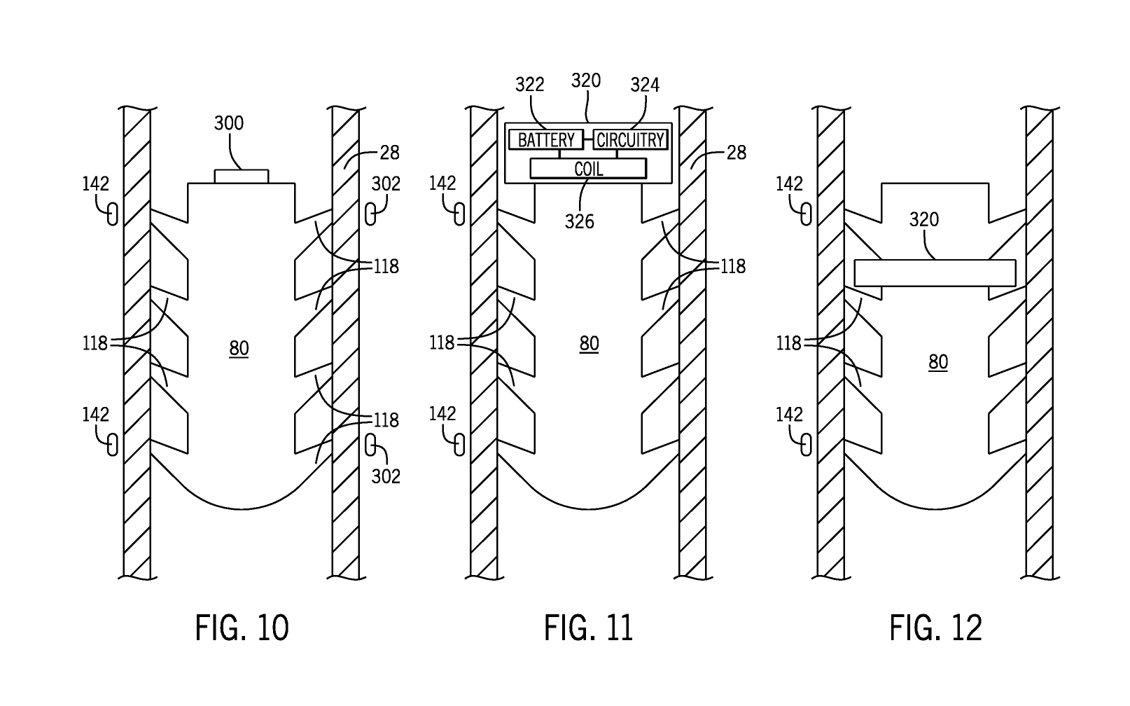

The magnets 110 may be coupled to the plug 80 via adhesive, an interference fit, a molding process, a sealant, or any other suitable manner. The plug 80 may include any suitable number of magnets 110, such as 1, 2, 3, 4, 5 magnets, or more. Additionally, the magnets 110 may be attached to an outer radial surface of the plug 80. For example, as shown in FIG. 2, magnets 110 may be attached to lateral sides 116 (e.g., radially outer surface) of fins 118 of the plug 80 (e.g., within a recess 120 of the lateral side 116). In some embodiments, a ferrous element (e.g., element 300 shown in FIG. 10) may be attached to the lateral side 116 of the fins 118. In certain embodiments, one or more magnets 110 may be attached to a lateral side 122 of a base 124 (e.g., a flared base) of the plug 80. Indeed, any outer radial surface of the plug 80 that contacts the inner surface of the casing string 28 may be suitable for attaching or coupling one or more magnets 110 to the plug 80 to increase the likelihood that the magnets 110 are detected by sensors of the sensor system 102 wrapped about the casing string 28. However, it will be appreciated that the one or more magnets 110 may be coupled to other areas or locations of the plug 80. The number, configuration, and arrangement of the magnets 110 are described in further detail below with reference to FIGS. 7-9.

FIG. 3 is a partial cut-away perspective view of an embodiment of the plug 80 positioned within the casing string 28 with the sensor system 102 of the plug detection system 100 coupled to an outer surface 130 of the casing string 28. As described above, the plug 80 is coupled to the casing drive system 70 by the casing drive system adapter 82, and cement is flowed through the casing drive system 70, the casing drive system adapter 82, and the plug 80 into the casing string 28 to complete a cementing process. Once the cementing process is completed, the ball launcher 78 launches the solid ball to occlude the ports (e.g., port 114) of the casing drive system adapter 82 and the plug 80. Thereafter, displacement fluid is pumped through the casing drive system 70 and behind the casing drive system adapter 82 and the plug 80 to build pressure and shear the shear pins 112, thereby launching the plug 80 down the casing string 28 to clear cement along the inner wall of the casing string 28.

To enable cement clearing along the inner wall of the casing string 28, the fins 118 and the base 124 of the plug 80 abut the inner wall of the casing string 28 via an interference fit when the plug 80 is positioned within the casing string 28. More particularly, the lateral sides 116 of the fins 118 and the lateral side 122 of the base 124 engage and abut the inner wall of the casing string 28. Thus, magnets 110 positioned on the lateral sides 116 and 122 also abut the inner wall of the casing string 28, which enables and improves detection of the magnetic fields of the magnets 110 by the sensor system 102.

As mentioned above, the sensor system 102 includes a belt 140 (e.g., band, strap, clamp, etc.) that wraps around the outer surface 130 of the casing string 28. More specifically, the belt 140 of the sensor system 102 is wrapped around the outer surface 130 of the casing string 28 axially beneath the plug 80, as shown in FIG. 3. In the illustrated embodiment, the belt 140 houses and supports sensors 142 (e.g., magnetometers) configured to detect the magnetic fields produced by the magnets 110 of the plug 80 shown in FIG. 2. However, as discussed below with reference to FIG. 10, other embodiments of the belt 140 may house magnets and sensors. When the plug 80 is launched, the sensors 142 detect the magnetic fields of the magnets 110 as the plug 80 passes the axial position of the belt 140 and sensors 142. This detection may be communicated to a user or operator via a master controller 144 of the sensor system 102. The sensor system 102 and its components (e.g., the sensors 142 and the master controller 144) may have various configurations and arrangements. Certain of these configurations and arrangements are described in further detail below.

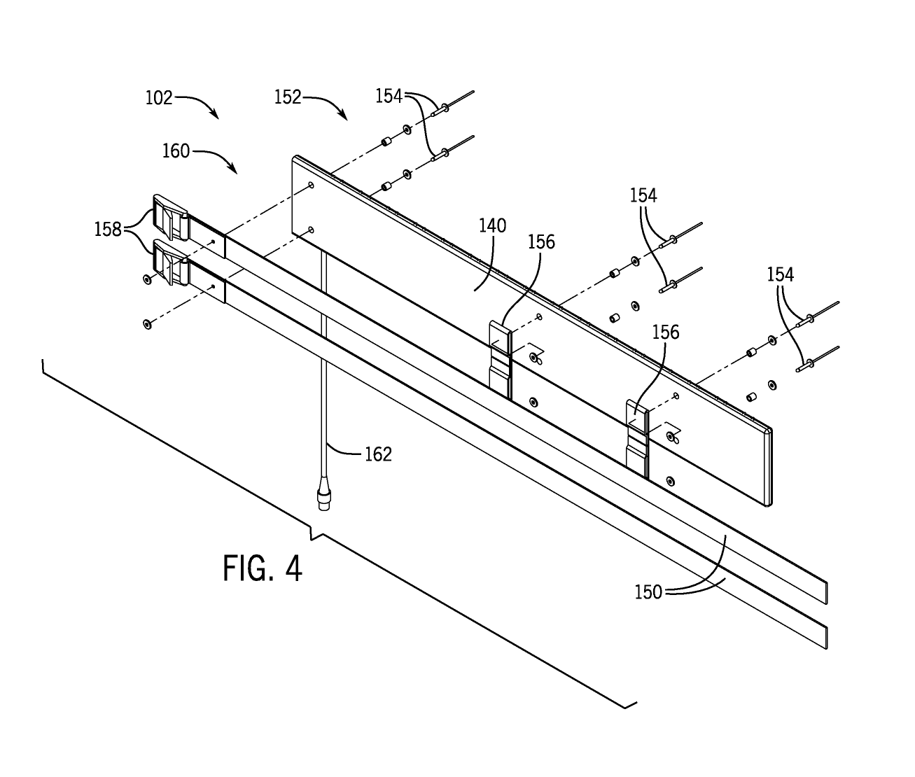

FIG. 4 is a partial exploded perspective view of an embodiment of the sensor system 102, illustrating the belt 140 and straps 150, which may be used to couple the belt 140 to the outer surface 130 of the casing string 28. The belt 140 may be made of a flexible material to enable wrapping of the belt 140 around the outer surface 130 of the casing string 28. The material used to form the belt 140 may also be durable, wear resistance, and/or corrosion resistant, such that the belt 140 is suitable for use in the environment of the drilling rig 10. For example, the belt 140 may be formed from rubber or other elastomer. The straps 150 may also be formed from a flexible and durable material, such as nylon webbing.

The straps 150 are fixed to the belt 140 at a first end 152 of the belt 140 via fasteners 154 (e.g., rivets, pins, bolts, screws, or the like). To couple the straps 150 to the remaining length of the belt 140, the sensor system 102 includes strap guides 156, which are also coupled to the belt 140 via fasteners 154. The straps 150 extend through the strap guides 156 to couple the straps 150 to the belt 140, while enabling relative movement of the straps 150 and the belt 140. In this manner, the straps 150 and belt 140 may be suitable for use with casing strings 28 of varying size (e.g., diameter). To this end, each of the straps 150 also includes a buckle 158 (e.g., locking fastener or fastening mechanism) at one end 160 of each respective strap 150. As will be appreciated, the buckles 158 enable tightening of the straps 150 when the belt 140 is positioned about the casing string 28 to secure the sensor system 102 to the casing string 28. The sensor system 102 further includes a cable 162, which couples the sensors 142 of the belt 140 to the master controller 144.

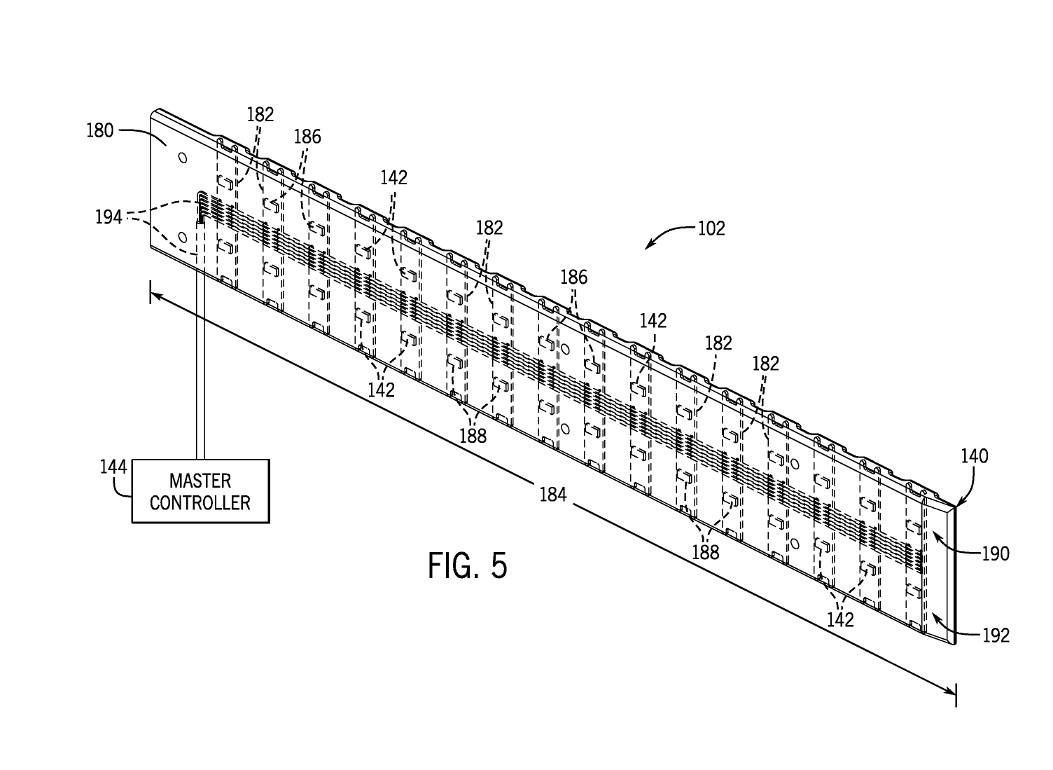

FIG. 5 is a perspective view of an embodiment of the sensor system 102, illustrating components of the belt 140. As shown, the belt 140 includes a main body 180 that supports a plurality of sensor boards 182 (e.g., printed circuit boards) spaced generally or substantially equidistantly along a length 184 of the main body 180. For example, “substantially” equidistant spacing between the sensor boards 182 may indicate that the spaces between the sensors boards 182 are each within 5 percent of the other respective spaces between other sensor boards 182. In other embodiments, the belt 140 may also support a plurality of magnet boards that generate a magnetic field for detection by the sensor boards 182. In certain embodiments, the sensor boards 182 (and/or magnet boards) may be molded to the main body 180 of the belt 140, which may be made of rubber or other elastomer. Additionally, the sensor boards 182 may each have a coating or encapsulating layer (e.g., silicone or other synthetic compound) to protect the sensor boards 182 and sensors 142, while also electrically isolating the sensor boards 182 and sensors 142 from the casing string 28 and one another. Each sensor board 182 includes a first sensor 186 (e.g., a top sensor) and a second sensor 188 (e.g., a bottom sensor). The sensor boards 182 may also include other circuitry, such as a microprocessor, transceiver, power management circuitry, and so forth, to enable the sending of signals from the sensors 142 (e.g., first and second sensors 186 and 188) to the master controller 144.

The first sensors 186 of the sensor boards 182 cooperatively form or define a first row or array 190 of sensors 142, while the second sensors 188 of the sensor boards 182 cooperatively form or define a second row or array 192 of sensors 142. Thus, when the belt 140 is secured to the outer surface 130 of the casing string 28, the first array of sensors 190 will be disposed at a first axial position along the casing string 28, and the second array of sensors 192 will be disposed at a second axial position (below the first axial position) of the casing string 28.

When the plug 80 is launched within the casing string 28, the plug 80 will travel down the casing string 28. Therefore, one or more of the first sensors 186 in the first array 190 will detect one or more of the magnets 110 of the plug 80. The one or more of the first sensors 186 that detects a magnetic field of one or more of the magnets 110 will send a detection signal to the master controller 144 via wires 194 coupling the sensors 142 and sensor boards 182 to the master controller 144. In certain embodiments, the detection signal may be filtered (e.g., with a digital high pass filter). As will be appreciated, the wires 194 may extend from the belt 140 to the master controller 144 via the cable 162 shown in FIG. 4. As the plug 80 continues to travel down the casing string 28, the magnets 110 of the plug 80 will reach the axial position of the second sensors 188 of the second array 192. The one or more second sensors 188 that detect the magnetic field of the one or more magnets 110 will then send a detection signal to the master controller 144 via wires 194. In certain embodiments, the detection signal may be filtered with a digital high-pass filter. The multiple arrays 190 and 192 of sensors 142 provide redundancy and provide additional confirmation of a detected launch of the plug 80. Additionally, data from the multiple arrays 190 and 192 may be analyzed together to provide additional information (e.g., a speed of the plug 80 passing through the casing string 28). Furthermore, while the illustrated embodiment has two arrays 190 and 192 of sensors 142, other embodiments of the sensor system 102 may include one array of sensors 142 (e.g., as shown in FIG. 3) or more than two arrays of sensors 142. Additionally, in certain embodiments, multiple belts 140 with sensors 142 may be used to detect launching of the plug 80 in the casing string 28.

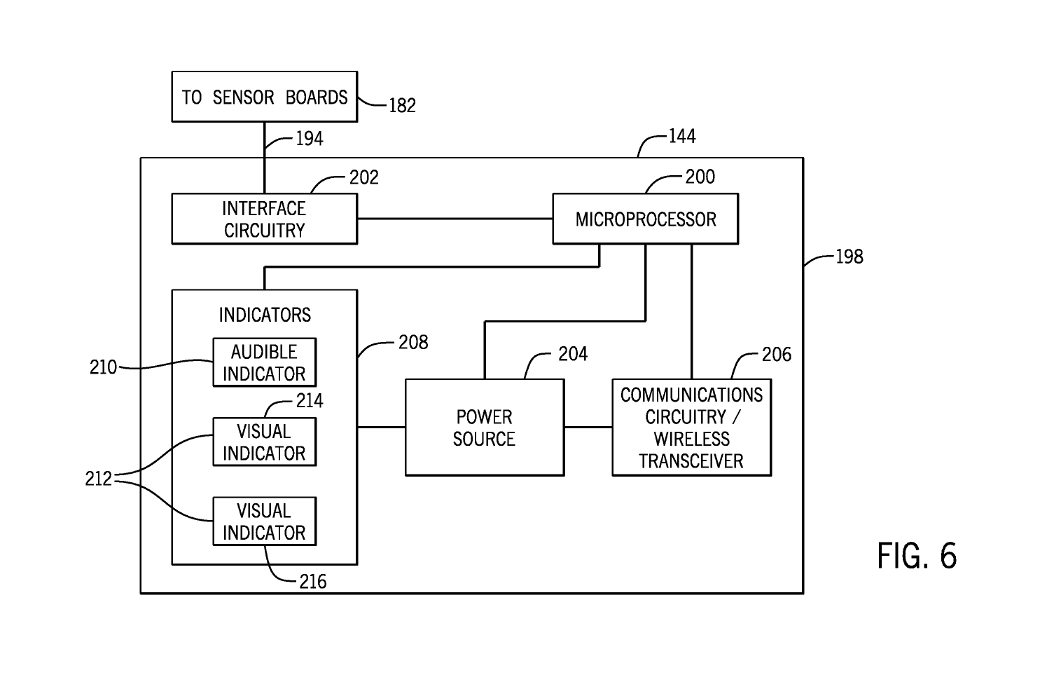

FIG. 6 is a schematic of an embodiment of the master controller 144 of the sensor system 102, illustrating various components of the master controller 144. Specifically, the master controller 144 includes a housing 198 (e.g., a metal or plastic housing) that houses components, such as a microprocessor 200, interface circuitry 202, a power source 204, communications circuitry 206 (e.g., a wireless transceiver), and indicators 208. As mentioned above, the master controller 144 may be coupled to the belt 140 via the cable 162, which includes the wires 194 that couple the sensor boards 182 and sensors 142 (and/or magnet boards of the belt 140) to the master controller 144.

The interface circuitry 202 is configured to communicate with the sensor boards 182 (and/or magnet boards) and the respective sensors 142 (or magnets) of each sensor board 182 (or magnet board). For example, when one of the sensors 142 of the belt 140 detects a magnetic field (e.g., from the magnet 110 of the plug 80), the detection signal sent by the sensor 142 that detected the magnetic field is received by the interface circuitry 202. The interface circuitry 202 then sends the detection signal to the microprocessor 200, which processes the detection signal. Before or after processing, the detection signal may be filtered with a high-pass digital filter. For example, the microprocessor 200 may output control signals based on the receipt of the detection signal. In certain embodiments, the output control signals may be directed to the indicators 208. The indicators 208 can include an audible indicator 210 (e.g., a speaker) and/or visual indicators 212 (e.g., light emitting diodes). For example, if one of the first sensors 186 in the first array 190 of sensors 142 detects a magnetic field emitted by the magnet 110, the microprocessor 200 may output a control signal to activate a first visual indicator 214. In one embodiment, the first indicator 214 may be an LED labeled “Top” to indicate that actuation of the first indicator 214 means that one of the sensors 186 in the first array 190 (e.g., top array) has detected the magnet 110 of the plug 80. Similarly, a second indicator 216 may be an LED labeled “Bottom” to indicate that actuation of the second indicator 216 means that one of the sensors 188 in the second array 192 has detected the magnet 110 of the plug 80. Thus, during a proper launch of the plug 80, the first indicator 214 may illuminate, followed by illumination of the second indicator 216. As will be appreciated, the microprocessor 200 may output control signals to actuate any one of the indicators 208 in other circumstances and/or to indicate other events or provide other feedback, such as a premature launch of the plug 80.

The microprocessor 200 may also output control signals to the communications circuitry 206 (e.g., wireless transceiver) in response to detection signals (e.g., filtered detection signals) received from the interface circuitry 202. For example, in response to a control signal output by the microprocessor 200, the communications circuitry 206 may send a signal (e.g., a wireless or wired signal) to a remote receiver, the control system 50, another user interface, or other computer system of the drilling rig 10 to indicate that the plug 80 has launched down the casing string 28. The master controller 144 further includes the power source 204, which supplies power to the components of the master controller 144 (e.g., the microprocessor 200, the communications circuitry 206, the indicators 208, etc.). In certain embodiments, the power source 204 may be a battery, such as a lithium battery.

FIGS. 7-9 are schematic top views of different embodiments of the plug detection system 100, illustrating various configurations of magnets 110 and sensors 142 that may be used in the plug detection system 100. It should be noted that FIGS. 7-9 are simplified to focus on the arrangement of the magnets 110 and sensors 142 and, thus, may not show other components described above (e.g., belt 140, master controller 144, etc.) that may be included with the plug detection system 100. FIG. 7 illustrates the plug detection system 100 where the plug 80 includes three magnets 110. As discussed above, each of the magnets 110 may be positioned on a lateral or radially outer surface of the plug, such as the lateral sides 116 and/or 122. Additionally, in the illustrated embodiment, the three magnets 110 are spaced generally equidistantly about a circumference 240 of the plug 80. In other words, the three magnets 110 are spaced approximately 120 degrees apart from one another. The magnets 110 may also be placed at a common axial location of the plug 80 (e.g., on the same fin 116). In order to achieve a high degree of confidence that at least one of the magnets 110 is detected by the sensor system 102, the sensor system 102 includes a multitude of the sensors 142 disposed about the casing string 28. A spacing 242 between adjacent sensors 142 of the sensor system 102 may be selected to be less than a width 244 of a detection region of each respective sensor 142 to ensure that at least one sensor 142 will detect the present of one of the magnets 110 regardless of the location of the magnets 110.

FIG. 8 illustrates an embodiment of the plug detection system 100 where the plug 80 includes one magnet 110, where the magnet 110 is a continuous magnet. In other embodiments, the continuous magnet may be a continuous ferrous element (e.g., non-magnetized ferrous element). For example, the magnet 110 shown in FIG. 8 may be a flexible magnetic strip, a magnetic ring, or other form of continuous magnet 110. The magnet 110 extends substantially entirely about the circumference 240 of the plug 80. However, ends 246 of the continuous magnet 110 may not connect with one another, as long as a gap 248 between the ends 246 of the continuous magnet 110 is smaller than the width 244 of the detection region of each sensor 142.

FIG. 9 illustrates an embodiment of the plug detection system 100 where the plug 80 includes multiple magnets 110, and the sensor system 102 includes one sensor 142. The magnets 110 may be coupled to the plug 80 as similarly described above. The sensor 142 may also be coupled to the belt 140 as similarly described above. The multiple magnets 110 may be spaced generally equidistantly. For example a spacing 250 between adjacent magnets 110 may be selected to be less than a width 252 of a detection region of the sensor 142 to ensure that the sensor 142 will detect the present of at least one magnet 110 regardless of the location of the sensor 142.

It will be appreciated that the plug 80 and the sensor system 102 may have numbers and configurations of magnets 110 and sensors 142, respectively, which are different from those disclosed herein. For example, in one embodiment, the plug 80 may have two magnets 110 disposed on opposite sides of the plug 80 from one another, and the belt 140 may have a number of sensors 142 such that only half of the casing string 28 is wrapped with a portion of the belt 140 having the sensors 142.

FIG. 10 is a schematic cross-sectional view of an embodiment of the plug detection system 100, illustrating the plug 80 having a ferrite element (e.g., a ferrous material or element) 300. For example, the ferrite element 300 may be an iron element or other non-magnetized ferrous element. In certain embodiments, the ferrite element 300 may be coupled to an exterior surface of the plug 80 (e.g., to one or more of the fins 118) or may be integrated (e.g., molded) within an interior of the plug 80. In other embodiments, the ball that blocks the port of the plug 80 may include the ferrite element 300.

In the illustrated embodiment, the plug detection system 80 includes sensors 142 (e.g., external and/or horizontal sensors) and external magnets 302. For example, the sensors 142 and/or external magnets 302 may be components of the belt 140 described above, such that the sensors 142 and/or external magnets 302 are wrapped round the exterior surface of the casing 28. However, in other embodiments, the sensors 142 and/or the external magnets 302 may be drilled into the casing 28.

In operation, the external magnets 302 generate a magnetic field around and/or within the casing 28, and the sensors 142 detect the magnetic field. When the plug 80 (and/or ball) is launched down the casing 28, the ferrite element 300 will extend and/or interrupt the magnetic field generated by the external magnets 302. This extension or interruption of the magnetic field is detected by the sensors 142 of the plug detection system 100. In a manner similar to that described above, the detection is communicated to the master controller 144 to confirm that the plug 80 has been launched down the casing 28. In certain embodiments, the external magnets 302 may be arranged about the casing 28 (e.g., via a particular arrangement of the external magnets 302 in the belt 140) in such a way that the plug 80 with the ferrite element 300 produces a unique or identifiable response in the sensors 142 to further verify and detect that the plug 80 has launched down the casing 28.

FIGS. 11 and 12 are a schematic cross-sectional views of an embodiment of the plug detection system 100, illustrating the plug 80 having an electro-magnetic pulse generator 320 (e.g., electro-magnetic transmitter). For example, in the illustrated embodiment of FIG. 11, the electro-magnetic pulse generator 320 includes a battery 322, electronics circuitry 324, and a coil 326. Additionally, the electro-magnetic pulse generator 320 shown in FIG. 11 is coupled to an exterior of the plug 80. FIG. 12 illustrates the electro-magnetic pulse generator 320 integrated within (e.g., molded within) the plug 80, such that the electro-magnetic pulse generator 320 is an internal or substantially internal component of the plug 80. The electro-magnetic pulse generator 320 may be a self-contained puck, ring, or other component that is connected to or disposed within the plug 80.

In operation, the electro-magnetic pulse generator 320 produces an electromagnetic field. Specifically, the battery 322 supplies power to the coil 326, which outputs the electromagnetic field. In certain embodiments, the electronics circuitry 324 may produce a unique pulse, frequency, or other modulation in the electromagnetic field that is uniquely identifiable to the sensors 142 of the plug detection system 100. As will be appreciate, a unique pulse, frequency, or other modulation in the electromagnetic field may improve confirmation or detection that the plug 80 has launched down the casing 28. As similarly discussed above with reference to FIG. 10, the sensors 142 may be components of the belt 140 described above, such that the sensors 142 are wrapped round the exterior surface of the casing 28. However, in other embodiments, the sensors 142 may be drilled into the casing 28.

When the plug 80 having the electro-magnetic pulse generator 320 is launched down the casing 28, the sensors 142 of the plug detection system 100 detect the electromagnetic field produced by the electro-magnetic pulse generator 320 as the plug 80 passes the sensors 142. In a manner similar to that described above, the detection is communicated to the master controller 144 to confirm that the plug 80 has been launched down the casing 28.

As will be appreciated, the embodiments and components described with reference to FIGS. 10-12 may include similar features, variations, and/or configurations to those discussed above with reference to FIGS. 2-9. For example, the embodiments described with reference to FIGS. 10-12 may include the belt 140, master controller 144, and so forth. For example, the sensors 142 and external magnets 302 may be incorporated with an embodiment of the belt 140. The master controller 144 may be used to process detection, communicate detection, and so forth that is detected by the sensors 142 in the embodiments of FIGS. 10-12. Indeed, any of the features described above with reference to any of FIGS. 1-12 may be used with one another in any of the configurations, arrangements, and so forth, described above.

As described in detail above, present embodiments include the plug detection system 100 having at least one magnet 110, ferrous element 300, or electro-magnetic pulse generator 320 coupled to the plug 80 for generating or altering a static or alternating magnetic field inside casing string 28 when the plug 80 is positioned within the casing string 28. The plug detection system 100 also includes the sensor system 102 with one or more sensors 142 and/or external magnets 302 positioned on the outer surface 130 of the casing string 28 to detect the magnetic field. In other embodiments, the sensors 142 and/or external magnets 302 may be positioned within (e.g., drilled within) the casing 28.

In certain embodiments, the sensor system 102 includes the band 140 to secure the one or more sensors 142 (and/or external magnets 302) to the outer surface 130 of the casing string 28. Before a cementing process is completed, the plug 80 with the magnet 110 (or ferrous element 300, or electro-magnetic pulse generator 320) is positioned or “stabbed” into the casing or tubular. Thereafter, the belt 140 having the one or more sensors 142 (and/or external magnets 302) is wrapped about the casing string 28 and moved up and down the casing string 28 until the sensors 142 indicate detection of the plug 80 (e.g., the magnet 110 coupled to the plug 80). Once the approximate location of the plug 80 is detected, the belt 140 is secured to the casing string 28 beneath the plug 80. The ball to block the port of the plug 80 is launched and displacement fluid is then pumped into the casing string 28 above the plug 80. Once the plug 80 is launched down the casing string 28 by the displacement fluid, the sensors 142 of the belt 140 will detect the magnet 110 of the plug 80 (or a change in the magnetic field produced by the external sensors 302 or a magnetic field generated by the electro-magnetic pulse generator 320) as the plug 80 travels down the casing string 28 past the sensors 142 and provide an indication to a user or operator, thereby confirming a positive launch of the plug 80.

As will be appreciated, the disclosed embodiments provide benefits over existing systems. For example, the disclosed plug detection system 100 may be a low voltage, low current, and otherwise low energy system, which may reduce costs associated with plug detection while also increasing safety. Additionally, the magnetic operation of the plug 80 detection may be particularly suitable for environments with the drilling rig 10 because operation of magnets 110, ferrous elements 300, pulse generators 320, magnet sensors 142, and so forth, may not be affected by dust, particulate matter, or other debris that may affect operation of other systems. Furthermore, the plug detection system 100 disclosed herein does not require penetration of the casing string 28 (e.g., for wires, sensors, etc.) or sight of the plug 28.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A cement plug detection system, comprising:
a cement plug comprising a ferrous element; and
a sensor system, comprising:
a belt configured to be disposed about a casing string;
a plurality of magnet sensors coupled to the belt;
a plurality of magnets coupled to the belt, wherein the plurality of magnets is configured to output a magnetic field; and
a master controller configured to provide an indication that at least one of a plurality of magnet sensors has detected a change in the magnetic field of the plurality of magnetics caused by the ferrous element.

2. The cement plug detection system of claim 1, wherein the cement plug comprises a plurality of fins, and the ferrous element is coupled to an outer radial surface of one or more of the plurality of fins.

3. The cement plug detection system of claim 1, wherein the sensor system comprises a plurality of sensor boards coupled to the belt, and a respective two magnet sensors of the plurality of magnet sensors are coupled to each sensor board of the plurality of sensor boards.

4. The cement plug detection system of claim 3, wherein the belt comprises a main body formed from an elastomer, and the plurality of sensor boards, the plurality of magnet sensors, and the plurality of magnets are molded to the main body of the belt.

5. The cement plug detection system of claim 4, wherein the belt comprises at least one strap having a locking fastener, wherein the at least one strap and locking fastener are configured to adjustably secure the sensor system to the casing string.

6. The cement plug detection system of claim 1, wherein the cement plug comprises a port configured to enable a flow of cement through the cement plug.

7. The cement plug detection system of claim 1, wherein the master controller comprises at least one visual indicator configured to provide the indication that the at least one magnet sensor of the plurality of magnet sensors has detected the change in the magnetic field of the plurality of magnets.

8. The cement plug detection system of claim 7, wherein the at least one visual indicator comprises a light emitting diode.

9. The cement plug detection system of claim 1, wherein the master controller comprises a wireless transceiver configured to wirelessly transmit the indication that the at least one of the plurality of magnet sensors has detected the change in the magnetic field of the plurality of magnets to a remote receiver.

10. A system, comprising:
a cement plug comprising an electro-magnetic pulse generator configured to output an electro-magnetic field; and
a sensor system, comprising
a belt configured to be disposed about a casing string; and
a plurality of sensor boards coupled to the belt, wherein each sensor board of the plurality of sensor boards comprises a first sensor and a second sensor, wherein the first sensors of the plurality of sensor boards are arranged in a first sensor array, and the second sensors of the plurality of sensor boards are arranged in a second sensor array.

11. The system of claim 10, wherein the sensor system comprises a master controller configured to receive a detection signal from each of the first and second sensors of each sensor board of the plurality of sensor boards upon detection of the electro-magnetic field by the respective first sensor or the respective second sensor of the respective sensor board.

12. The system of claim 11, wherein the master controller is configured to activate at least one indicator to indicate receipt of the detection signal from one of the plurality of sensor boards.

13. The system of claim 12, wherein the at least one indicator comprises a first visual indicator and a second visual indicator, wherein the master controller is configured to activate the first visual indicator when the detection signal is received from one of the first sensors, and the master controller is configured to activate the second visual indicator when the detection signal is received from one of the second sensors.

14. The system of claim 10, wherein the electro-magnetic pulse generator comprises a battery and a coil, wherein the coil is configured to output the electro-magnetic field.

15. The system of claim 14, wherein the electro-magnetic pulse generator comprises electronics circuitry, wherein the electronics circuitry is configured to produce a unique pulse, modulation, or frequency in the electro-magnetic field, and wherein the first and second sensors of each sensor board of the plurality of sensor boards is configured to detect the unique pulse, modulation, or frequency in the electro-magnetic field.

16. A method, comprising:
positioning a cement plug in a casing string;
completing a casing cementing process;
launching the cement plug down the casing string;
detecting a magnetic field of an electro-magnetic transmitter coupled to the cement plug or a magnet disposed on an outer surface of the casing string with a magnetic sensor disposed on the outer surface of the casing string.

17. The method of claim 16, comprising providing an indication to an operator that the magnetic field is detected with the magnetic sensor disposed on the outer surface of the casing string.

18. The method of claim 17, wherein providing the indication to the operator that the magnetic field is detected with the magnetic sensor disposed on the outer surface of the casing string comprises illuminating a light emitting diode of a master controller coupled to the magnetic sensor.

19. The method of claim 16, wherein detecting the magnetic field of the electro-magnetic transmitter coupled to the cement plug or the magnet disposed on the outer surface of the casing string comprises detecting a change in the magnetic field of the magnet disposed on the outer surface of the casing string, wherein the change is created by a ferrous element coupled to the cement plug launching down the casing string.

20. The system of claim 16, comprising securing a belt comprising the magnetic sensor about the casing string before launching the cement plug down the casing string.
